(19) United States
(12) Patent Application Publication
(10) Pub. No.: US 2023/0420928 A1
(43) Pub. Date: Dec. 28, 2023

(54) DIRECT CURRENT CIRCUIT BREAKER AND PROTECTION SYSTEM

(71) Applicant: ABB Schweiz AG, Baden (CH)

(72) Inventors: Jia Meng, Beijing (CN); Zhixiang Wang, Beijing (CN); Yibo Zhang, Beijing (CN)

(21) Appl. No.: 18/252,976

(22) PCT Filed: Dec. 2, 2020
(86) PCT No.: PCT/CN2020/133364

§ 371 Date: May 15, 2023

(51) Int. Cl. H02H 3/087; H02H 3/02; H01H 33/59

(52) U.S. Cl. CPC H02H 3/087; H02H 3/021; H01H 33/596

(57) ABSTRACT

Embodiments of present disclosure relate to a direct current circuit breaker and a protection system. The direct current circuit breaker comprises a switch module comprising a first switch and a second switch connected in series between a first terminal of the direct current circuit breaker and a second terminal of the direct current circuit breaker; a current injecting module comprising an inductor, a current injecting switch, and a capacitor connected in series between the first terminal of the direct current circuit breaker and an intermediate node between the first switch and the second switch; an energy absorbing module connected in parallel with the current injecting switch and the capacitor or in parallel with the first switch and configured to limit a voltage across the capacitor to a predetermined level; and a pre-charge module connected in parallel with the capacitor and configured to pre-charge the capacitor.

### FIELD

Embodiments of the present disclosure generally relate to the field of direct current circuit breakers, and more particularly, to a direct current circuit breaker with a current injecting switch.

### BACKGROUND

With the increasing use of renewable energy and direct current (DC) power, the building of DC distribution networks is increasing. As one of the key pieces of equipment in DC distribution networks, direct current circuit breakers are increasingly being used.

The operating principle of a mechanical type DC circuit breaker in a DC distribution network is to use a pre-charged capacitor and a reactor to form an LC oscillating circuit. The discharge of the pre-charged capacitor would generate a high-frequency oscillating current whose peak value is higher than a system current of the DC distribution network flowing through the DC circuit breaker. When the high-frequency oscillating current is superimposed with the system current, a zero crossing of the current occurs in the circuit breaker, and the DC circuit breaker cuts off the current near the zero crossing point.

At present, the mechanical type DC circuit breakers are more cost effective compared with solid-state and hybrid circuit breakers. As a result, the mechanical type DC circuit breakers are suitable for the popularization of DC circuit breakers in the DC distribution networks.

However, the mechanical type DC circuit breakers usually have a long breaking time. As the DC short current rises quickly, the longer the breaking time is, the harder is the current breaking. Therefore, a long breaking time of the DC circuit breaker may lead to a failure of the current breaking. In addition, the mechanical type DC circuit breakers need to use dual pre-charged capacitor circuits in fast reclosing applications. Accordingly, the number of capacitors used in the mechanical type DC circuit breakers is doubled, resulting in a complicated circuit breaker structure with large volume and high cost.

Thus, there is a need for an approach for reducing the breaking time of the mechanical type DC circuit breakers and realizing bidirectional current fast-reclosing function of the DC circuit breakers without additional pre-charged capacitor circuit.

### SUMMARY

In view of the foregoing problems, various example embodiments of the present disclosure provide a direct current circuit breaker for reducing the breaking time of the mechanical type DC circuit breakers and realizing bidirectional current fast-reclosing function of the DC circuit breakers without additional a pre-charged capacitor circuit.

In a first aspect of the present disclosure, example embodiments of the present disclosure provide a direct current circuit breaker. The direct current circuit breaker comprises a switch module comprising a first switch and a second switch connected in series between a first terminal of the direct current circuit breaker and a second terminal of the direct current circuit breaker; a current injecting module comprising an inductor, a current injecting switch, and a capacitor connected in series between the first terminal of the direct current circuit breaker and an intermediate node between the first switch and the second switch; an energy absorbing module connected in parallel with the current injecting switch and the capacitor or in parallel with the first switch and configured to limit a voltage across the capacitor to a predetermined level; and a pre-charge module connected in parallel with the capacitor and configured to pre-charge the capacitor.

In some embodiments, the current injecting switch comprises a thyristor and a diode in anti-parallel connection with the thyristor, and wherein an anode of the thyristor is connected to the capacitor, and a cathode of the thyristor is connected to the inductor.

In some embodiments, the current injecting switch comprises an IGBT and a diode in anti-parallel connection with the IGBT, and wherein a drain of the IGBT is connected to the capacitor, and a source of the IGBT is connected to the inductor.

In some embodiments, the energy absorbing module comprises a Varistor.

In some embodiments, the pre-charge module comprises a power supply and a resistor connected in series with each other.

In some embodiments, the first switch comprises a multi-break electromagnetic repulsion vacuum switch.

In a second aspect of the present disclosure, example embodiments of the present disclosure provide a protection system for a direct current power distribution network. The protection system comprises a direct current circuit breaker according to the first aspect of the present disclosure; a sensor configured to detect a malfunction that occurred in the direct current power distribution network and generate a malfunction signal in response to the detected malfunction; and a controller connected to the current injecting switch and the sensor, and configured to turn on the current injecting switch in response to receiving the malfunction signal from the sensor.

In some embodiments, the controller is further connected to the first switch and configured to close the first switch after the first switch is opened for a preset time.

In some embodiments, the preset time is 100 ms.

It is to be understood that the Summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in examples and in a non-limiting manner, wherein:

FIG. 1 (a) is a schematic diagram illustrating a circuit structure of a direct current circuit breaker in accordance with an embodiment of the present disclosure;

FIG. 1 (b) is a schematic diagram illustrating a circuit structure of a direct current circuit breaker in accordance with another embodiment of the present disclosure;

FIG. 2 is a schematic diagram illustrating a circuit structure of a direct current circuit breaker in accordance with another embodiment of the present disclosure;

FIG. 3 is a schematic diagram illustrating the operating principle of the direct current circuit breaker as shown in FIG. 2 when the system current flows in a first direction;

FIG. 4 is a graph illustrating a relationship between a current and a voltage of a capacitor in the direct current circuit breaker as shown in FIG. 3;

FIG. 5 is a graph illustrating a current of a mechanical switch in the direct current circuit breaker as shown in FIG. 3;

FIG. 6 is a schematic diagram illustrating the operating principle of the direct current circuit breaker as shown in FIG. 2 when the system current flows in a second direction;

FIG. 7 is a graph illustrating a relationship between a current and a voltage of a capacitor in the direct current circuit breaker as shown in FIG. 6 when a mechanical switch is opened for a first time;

FIG. 8 is a graph illustrating a current of a mechanical switch in the direct current circuit breaker as shown in FIG. 6 when a mechanical switch is opened for a first time;

FIG. 9 is a graph illustrating a current and a voltage of a capacitor in the direct current circuit breaker as shown in FIG. 6 when a mechanical switch is opened for a second time;

FIG. 10 is a graph illustrating a current of a mechanical switch in the direct current circuit breaker as shown in FIG. 6 when a mechanical switch is opened for a second time; and

FIG. 11 is a block diagram illustrating a protection system for a direct current power distribution network in accordance with an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to embodiments of the present disclosure, a current injecting switch is used in the DC circuit breaker so as to realize bidirectional current fast-reclosing function of the DC circuit breakers without additional a pre-charged capacitor circuit. Moreover, a multi-break electromagnetic repulsion vacuum switch is used in the DC circuit breaker so as to reduce the breaking time of the mechanical type DC circuit breaker. The above idea may be implemented in various manners, as will be described in detail in the following paragraphs.

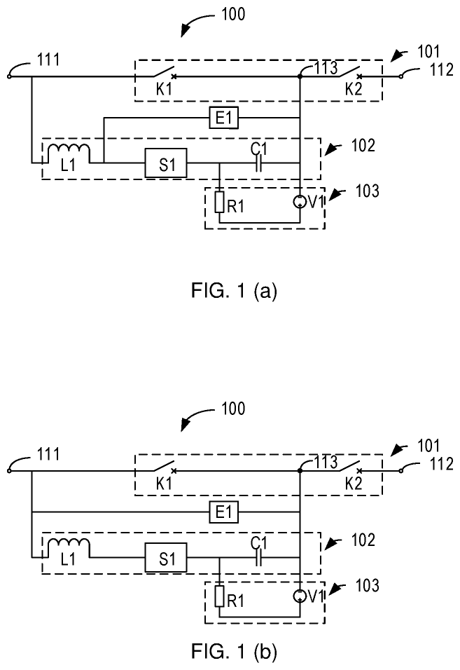

Hereinafter, the principles of the present disclosure will be described in detail with reference to FIGS. 1 (a)-11. Referring to FIG. 1 (a) first, FIG. 1 (a) is a schematic diagram illustrating a circuit structure of a direct current circuit breaker in accordance with an embodiment of the present disclosure. As shown in FIG. 1 (a), the direct current circuit breaker 100 generally includes a switch module 101, a current injecting module 102, an energy absorbing module E1, and a pre-charge module 103. A system current can flow through the switch module 101 from a first terminal 111 to a second terminal 112 of the direct current breaker circuit 100, or the system current can flow through the switch module 101 from the second terminal 112 to the first terminal 111 of the direct current breaker circuit 100.

The switch module 101 generally includes a first switch K1 and a second switch K2 connected in series between the first terminal 111 and the second terminal 112. The first switch K1 is used to cut off the system current flowing through the first switch K1 when a malfunction in the DC distribution network occurs. The second switch K2 is used to cut off a residual current flowing through the second switch K2.

In some embodiments, the first switch K1 includes a multi-break electromagnetic repulsion vacuum switch. Compared to a single-break electromagnetic repulsion vacuum switch, the contact opening distance required for current breaking is reduced because multiple contacts in the multi-break electromagnetic repulsion vacuum switch can move simultaneously. Accordingly, the opening time of the mechanical switch (from the time instant that the mechanical switch receives the trip signal to the time instant that the contact is opened to withstand the Transient Interruption Voltage, TIV) is reduced, such that the breaking time is reduced.

In some embodiments, the multi-break electromagnetic repulsion vacuum switch may include two breaks. In other embodiments, the multi-break electromagnetic repulsion vacuum switch may include other numbers of breaks, such as three, four, or more. The scope of the present disclosure is not intended to be limited in this respect.

In some embodiments, the second switch K2 is of the same type as the first switch K1. In other embodiments, the second switch K2 is of the different type from the first switch K1. For example, the first switch K1 is a multi-break electromagnetic repulsion vacuum switch, and the second switch K2 is a contactor. The scope of the present disclosure is not intended to be limited in this respect.

The current injecting module 102 generally includes an inductor L1, a current injecting switch S1, and a capacitor C1 connected in series between the first terminal 111 and an intermediate node 113 between the first switch K1 and the second switch K2. The capacitor C1 and the inductor L1 form an LC oscillating circuit. When the current injecting switch S1 is turned on, the discharge of the pre-charged capacitor C1 would generate a high-frequency oscillating current whose peak value is higher than the system current. When the high-frequency oscillating current is superimposed with the system current, a zero crossing of current occurs in the first switch K1, and the first switch K1 cuts off the system current near the zero crossing point. The current injecting switch S1 enables the LC oscillating circuit to oscillate for several periods in order to generate multiple zero crossing points, until the first switch K1 is successfully opened near one of the zero crossing points. This can increase the success rate of the break.

With the arrangement of the direct current circuit breaker 100 as shown in FIG. 1 (a), the current injecting switch S1 is used instead of a mechanical switch used in the current injecting module 102 in conventional approaches. Since the conduction time of the current injecting switch S1 is usually at microsecond level, which is much higher than the millisecond level of the mechanical switch, rapid injection of the current can be realized, and short breaking time can be achieved with the current injecting switch S1. Moreover, the capacitor C1 can be charged through the current injecting switch S1 from the DC distribution network after the first switch K1 is opened, and can be charged to a predetermined level before the first switch K1 is opened again, such that the capacitor C1 has enough energy to provide an injected current so as to generate a zero crossing on the first switch K1 for a second time. Accordingly, the DC circuit breaker 100 realizes a bidirectional current fast-reclosing function without an additional pre-charged capacitor circuit.

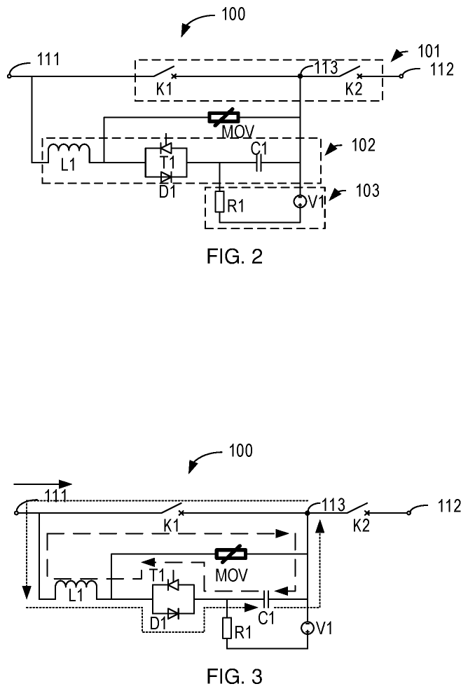

In an embodiment, as shown in FIG. 2, the current injecting switch S1 includes a thyristor T1 and a diode D1 in anti-parallel connection with the thyristor T1. An anode of the thyristor T1 is connected to the capacitor C1, and a cathode of the thyristor T1 is connected to the inductor L1. The thyristor T1 is more cost effective than other types of electronic switches.

In another embodiment, the current injecting switch S1 includes an IGBT and a diode D1 in anti-parallel connection with the IGBT. A drain of the IGBT is connected to the capacitor C1, and a source of the IGBT is connected to the inductor L1. In other embodiments, other types of switches can be used, such MOSFET, etc. The scope of the present disclosure is not intended to be limited in this respect.

As shown in FIG. 1 (a), the energy absorbing module E1 is connected in parallel with the current injecting switch S1 and the capacitor C1 so as to limit a voltage across the capacitor C1 to a predetermined level. In an embodiment as shown in FIG. 1 (b), the energy absorbing module E1 is connected in parallel with the first switch K1. When the voltage across the capacitor C1 exceeds a first predetermined voltage, for example, 15 kV, the energy absorbing module E1 is turned on, and the system current flows to the ground. Accordingly, the voltage across the capacitor C1 decreases. When the voltage across the capacitor C1 is lower than a second predetermined voltage, for example, 10 kV, the energy absorbing module E1 is turned off, and the voltage across the capacitor C1 is maintained at a constant level. As a result, the voltage across the capacitor C1 is limited by the energy absorbing module E1.

In an embodiment, as shown in FIG. 2, the energy absorbing module E1 includes a Varistor, such as, a Metal Oxide Varistor (MOV). In other embodiments, other types of energy absorbing components can be used. The scope of the present disclosure is not intended to be limited in this respect.

As shown in FIGS. 1 (a), 1 (b) and 2, the pre-charge module 103 is connected in parallel with the capacitor C1 and is configured to pre-charge the capacitor C1. Before the first switch K1 is opened, the current injecting switch S1 is turned off, and the energy cannot be transferred from the DC distribution network to the capacitor C1, the pre-charge module 103 is thus needed to provide the energy for the capacitor C1 to inject a current when the current injecting switch S1 is turned on.

In some embodiments, the pre-charge module 103 includes a power supply V1 and a resistor R1 connected in series with each other. The power supply V1 is connected to the capacitor C1 through the resistor R1 so as to charge the capacitor C1. The value of a charge current can be adjusted by varying the resistance value of the resistor R1.

In other embodiments, other types of pre-charge module 103 can be used. The scope of the present disclosure is not intended to be limited in this respect.

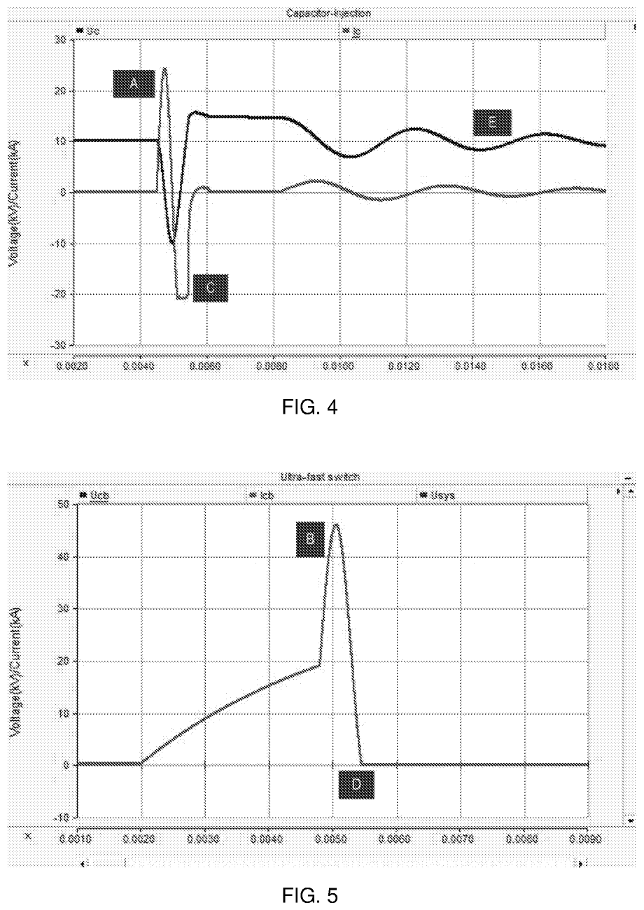

Hereinafter, the operating principles of the present disclosure will be described in detail with reference to FIGS. 3-10. Referring to FIGS. 3-5 first, FIG. 3 is a schematic diagram illustrating the operating principle of the direct current circuit breaker as shown in FIG. 2 when the system current flows in a first direction; FIG. 4 is a graph illustrating a relationship between a current and a voltage of a capacitor in the direct current circuit breaker as shown in FIG. 3; FIG. 5 is a graph illustrating a current of a mechanical switch in the direct current circuit breaker as shown in FIG. 3.

When a malfunction occurs in the DC distribution network, the thyristor T1 would be turned on, such that the discharge of the pre-charged capacitor C1 generates an injected current flowing through the thyristor T1. The direction of the first half wave of the injected current is shown as the long dotted line in FIG. 3, and the waveform of the current flowing through the first switch K1 is shown as mark A in FIG. 4. Then the injected current is superimposed on the system current. As the direction of the injected current is the same as the system current at this time (from the first terminal 111 to the intermediate node 113), a peak current at the first switch K1 is generated (FIG. 5 mark B).

As the oscillating of the injected current continues, the direction of the injected current changes. The thyristor T1 is turned off, and the injected current flows through the diode D1. The second half wave is shown as mark C in FIG. 4, and the direction of the injected current is shown as the short dotted line in FIG. 3. Then the injected current is superimposed on the system current. As the direction of the injected current (from the intermediate node 113 to the first terminal 111) is opposite to the system current (from the first terminal 111 to the intermediate node 113) at this time, and a peak value of the injected current is higher than the system current, a zero crossing of the current is generated. The first switch K1 cuts off the current at or around the zero crossing point (FIG. 5, mark D).

At this time, because the first switch K1 is opened, the system current will go through the diode D1 to charge the capacitor C1, and the voltage of the capacitor C1 is increased as shown in FIG. 4. When the voltage across the capacitor C1 exceeds the threshold value (15 kV in FIG. 4), the MOV is turned on, and the system current flows to the ground, such that the voltage across the capacitor C1 thus decreases. At last, the voltage across the capacitor C1 will drop back to the system voltage (10 kV in FIG. 4) within tens of milliseconds (FIG. 4, mark E).

In fast reclosing applications, the first switch K1 needs to be reclosed after the first switch K1 is opened for a period of time (for example, 100 ms), so as to test whether the malfunction in the DC distribution network is a transient malfunction. If the malfunction in the DC distribution network is not a transient malfunction, the first switch K1 needs to be opened for a second time. In this embodiment, the process of the second breaking operation is the same as the first breaking operation described above.

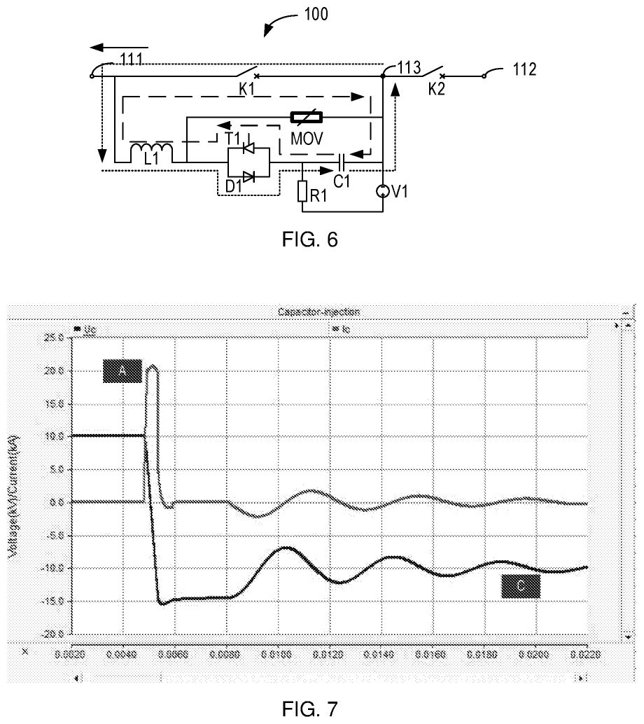

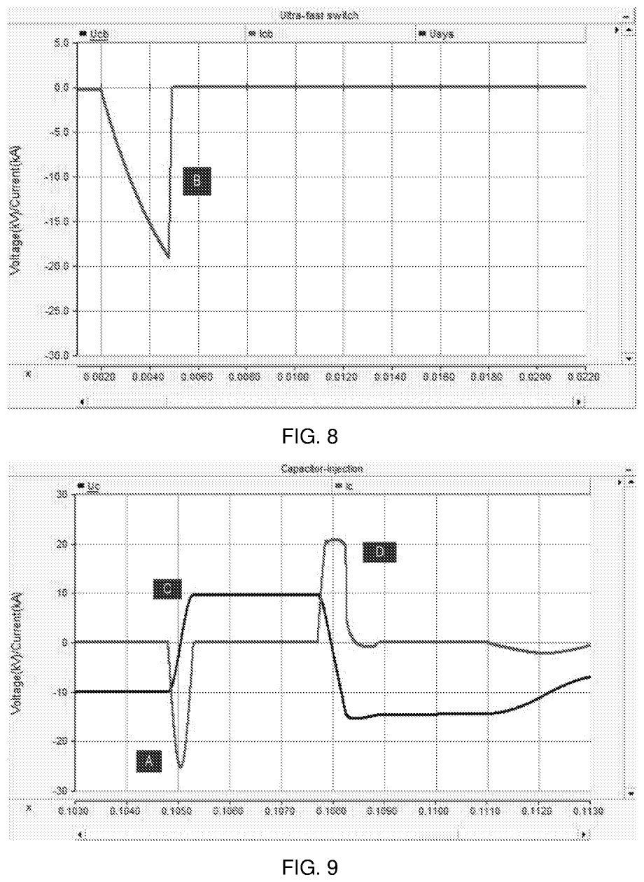

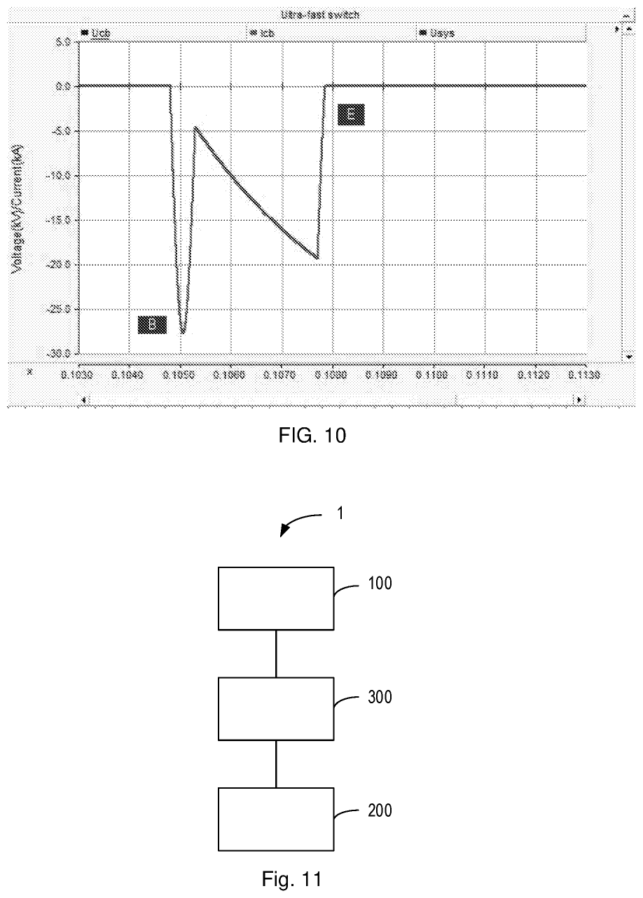

FIG. 6 is a schematic diagram illustrating the operating principle of the direct current circuit breaker as shown in FIG. 2 when the system current flows in a second direction; FIG. 7 is a graph illustrating a relationship between a current and a voltage of a capacitor in the direct current circuit breaker as shown in FIG. 6 when a mechanical switch first breaks; FIG. 8 is a graph illustrating a current of a mechanical switch in the direct current circuit breaker as shown in FIG. 6 when a mechanical switch first breaks; FIG. 9 is a graph illustrating a relationship between a current and a voltage of a capacitor in the direct current circuit breaker as shown in FIG. 6 when a mechanical switch secondly breaks; FIG. 10 is a graph illustrating a current of a mechanical switch in the direct current circuit breaker as shown in FIG. 6 when a mechanical switch secondly breaks.

In this instance, the capacitor C1 has polarity opposite to the system current (FIG. 6). When the thyristor T1 is turned on, the discharge of the pre-charged capacitor C1 generates an injected current flowing through the thyristor T1. The direction of the first half wave of the injected current is shown as a long dotted line in FIG. 6, and the waveform is shown as mark A in FIG. 7. The injected current is superimposed on the system current. As the direction of the injected current (from the first terminal 111 to the intermediate node 113) is opposite to the system current (from the intermediate node 113 to the first terminal 111) at this time, a zero crossing of the system current is generated, and the first switch K1 cuts off the current at or around the zero crossing point (FIG. 8, mark B).

At this time, the polarity of the capacitor C1 is opposite to its polarity at the time when the first switch K1 is not opened. Because the first switch K1 is opened, the system current flows through thyristor T1 to charge the capacitor C1, and the voltage across the capacitor C1 increases. When the voltage across the capacitor C1 exceeds the threshold value (−15 kV in FIG. 7), the MOV is turned on, and the system current flows to the ground, such that the voltage across the capacitor C1 decreases. At last, the voltage across the capacitor C1 will drop back to the system voltage (−10 kV in FIG. 7) within tens of milliseconds (FIG. 7, mark C).

After the first switch K1 has been opened for a period of time (for example, 100 ms), the first switch K1 is reclosed. The capacitor C1 is discharged through the diode D1, and the current is shown as the short dotted line in FIG. 6 and as mark A in FIG. 9. The thyristor T1 is turned off at this point. The discharge current is superimposed on the system current to generate a peak current at the first switch K1 (FIG. 10, mark B). The voltage of the capacitor C1 will be charged to nearly negative system voltage (10 kV in FIG. 9) because of the LC loop current oscillation (FIG. 9, mark C). When the thyristor T1 is turned on, the first half wave of the injected current (long dotted line in FIG. 6 and FIG. 9, mark D) is superimposed on the system current to produce a zero crossing, and the first switch K1 cuts off the current at or around the zero crossing point (FIG. 10, mark E).

Hereinafter, the principles of a protection system for a direct current power distribution network will be described in detail with reference to FIG. 11. The protection system for a direct current power distribution network generally includes a direct current circuit breaker 100 according to previous embodiments, a sensor 200, and a controller 300.

The sensor 200 is used to detect that a malfunction occurred in the direct current power distribution network and to generate a malfunction signal in response to the detected malfunction. In some embodiments, the sensor 200 includes an overcurrent detection sensor, overvoltage detection sensor, over-temperature sensor. In other embodiments, the sensor 200 may be of other types. The scope of the present disclosure is not intended to be limited in this respect.

The controller 300 is connected to the current injecting switch S1 and the sensor 200, and is used to turn on the current injecting switch S1 in response to receiving the malfunction signal from the sensor 200. In some embodiments, the controller 300 is connected to the first switch K1 and used to close the first switch K1 after the first switch K1 is opened for a preset time. In some embodiments, the controller 300 includes PLC. In other embodiments, the controller 300 includes other types of controllers. In some embodiments, the preset time is 100 ms. In other embodiments, the preset time can be other values, for example, 30 ms, 50 ms. The scope of the present disclosure is not intended to be limited in this respect.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A direct current circuit breaker comprising:
a switch module comprising a first switch and a second switch connected in series between a first terminal of the direct current circuit breaker and a second terminal of the direct current circuit breaker;
a current injecting module comprising an inductor, a current injecting switch, and a capacitor connected in series between the first terminal of the direct current circuit breaker and an intermediate node between the first switch and the second switch;
an energy absorbing module connected in parallel with the current injecting switch and the capacitor or in parallel with the first switch and configured to limit a voltage across the capacitor to a predetermined level; and
a pre-charge module connected in parallel with the capacitor and configured to pre-charge the capacitor.

2. The direct current circuit breaker according to claim 1,
wherein the current injecting switch comprises a thyristor and a diode in anti-parallel connection with the thyristor, and
wherein an anode of the thyristor is connected to the capacitor, and a cathode of the thyristor is connected to the inductor.

3. The direct current circuit breaker according to claim 1,
wherein the current injecting switch comprises an IGBT and a diode in anti-parallel connection with the IGBT, and
wherein a drain of the IGBT is connected to the capacitor, and a source of the IGBT is connected to the inductor.

4. The direct current circuit breaker according to claim 1, wherein the energy absorbing module comprises a Varistor.

5. The direct current circuit breaker according to claim 1, wherein the pre-charge module comprises a power supply and a resistor connected in series with each other.

6. The direct current circuit breaker according to claim 1, wherein the first switch comprises a multi-break electromagnetic repulsion vacuum switch.

7. A protection system for a direct current power distribution network, comprising:
a direct current circuit breaker according to claim 1;
a sensor configured to detect a malfunction occurred in the direct current power distribution network and generate a malfunction signal in response to the detected malfunction; and
a controller connected to the current injecting switch and the sensor, and configured to turn on the current injecting switch in response to receiving the malfunction signal from the sensor.

8. The protection system according to claim 7, wherein the controller is further connected to the first switch and configured to close the first switch after the first switch is opened for a preset time.

9. The protection system according to claim 8, wherein the preset time is 100 ms.

10. The protection system according to claim 7,
wherein the current injecting switch of the direct current circuit breaker comprises a thyristor and a diode in anti-parallel connection with the thyristor, and
wherein an anode of the thyristor is connected to the capacitor, and a cathode of the thyristor is connected to the inductor.

11. The protection system according to claim 10, wherein the controller is further connected to the first switch and configured to close the first switch after the first switch is opened for a preset time.

12. The protection system according to claim 7,
wherein the current injecting switch of the direct current circuit breaker comprises an IGBT and a diode in anti-parallel connection with the IGBT, and
wherein a drain of the IGBT is connected to the capacitor, and a source of the IGBT is connected to the inductor.

13. The protection system according to claim 12, wherein the controller is further connected to the first switch and configured to close the first switch after the first switch is opened for a preset time.

14. The protection system according to claim 7,
wherein the energy absorbing module comprises a Varistor.

15. The protection system according to claim 14, wherein the controller is further connected to the first switch and configured to close the first switch after the first switch is opened for a preset time.

16. The protection system according to claim 7,
wherein the pre-charge module comprises a power supply and a resistor connected in series with each other.

17. The protection system according to claim 16, wherein the controller is further connected to the first switch and configured to close the first switch after the first switch is opened for a preset time.

18. The protection system according to claim 7,
wherein the first switch comprises a multi-break electromagnetic repulsion vacuum switch.

19. The protection system according to claim 18, wherein the controller is further connected to the first switch and configured to close the first switch after the first switch is opened for a preset time.
